(19) United States
(12) Patent Application Publication
(10) Pub. No.: US 2014/0053414 A1
(43) Pub. Date: Feb. 27, 2014

(54) Cake Leveller

(71) Applicant: KNIGHTSBRIDGE PME LIMITED, Enfield (GB)

(72) Inventor: Yao Ling, Yuhang Hangzhou Zhejiang (CN)

(73) Assignee: KNIGHTSBRIDGE PME LIMITED, Enfield (GB)

(21) Appl. No.: 13/974,173

(22) Filed: Aug. 23, 2013

(30) Foreign Application Priority Data
Aug. 24, 2012 (GB) 1215179.1

(51) Int. Cl. B26B 27/00

(52) U.S. Cl. CPC B26B 27/002
USPC 30/278

(57) ABSTRACT

A cake leveller comprises a rigid frame 1 in the form of a bow with at least two taut intertwined wires 5, 6 extending horizontally between spaced parts 4 of the frame. In a particular example, four wires are all intertwined together in two pairs, the wires in each pair being of unequal thicknesses. The wires 5, 6 within the pairs may be intertwined more spatially frequently than the intertwining of the pairs.

### BACKGROUND TO THE INVENTION

This invention relates to a cake leveller.

A cake rises during baking, resulting in a somewhat domed or conical upper surface. It is generally desired to have a flat upper surface.

A known cake leveller comprises a rigid frame in the form of a bow with a wire extending horizontally between parallel parts of the frame. Ends of the frame are rested on a surface on which the cake stands and the frame is then moved across the cake, keeping the frame ends on the surface, so that the wire slices off the upper part of the cake, leaving a level upper surface of the cake.

In such a leveller it is known to provide a wire of “wavy”, in particular “sawtooth” form, as shown in FIG. 1. This is an attempt to provide a leveller that will cut through cakes of firmer consistency, such as fruit cakes. However this has had limited success.

A known Gigli saw, used by surgeons for bone cutting, has a flexible blade comprising intertwined wires.

### SUMMARY OF THE INVENTION

The present invention provides a cake leveller comprising a rigid frame in the form of a bow with at least two taut intertwined wires extending horizontally between spaced parts of the frame.

We have found that such a wire can cut smoothly through cakes of firmer consistency.

Two intertwined wires may be provided, which may be of unequal thicknesses. Alternatively, an intertwined pair of wires may be intertwined with at least one further intertwined pair of wires. In each pair, the wires may be of unequal thicknesses. The spatial frequency at which the thin wires are wrapped around the thick wires may be n times the spatial frequency at which the pairs of wires are wrapped around each other, n being an integer from 2 to 10 inclusive.

### BRIEF DESCRIPTION OF THE DRAWINGS

The invention will now be described in more detail, by way of example only, with reference to the accompanying drawings, in which:

FIG. 1 is a detail of a wire of a known cake leveller;

FIG. 2 shows a cake leveller according to an embodiment of the invention;

FIG. 3 shows a detail of the wires of the cake leveller of FIG. 2; and

FIG. 4 shows a single pair of intertwined wires of the leveller of FIG. 2.

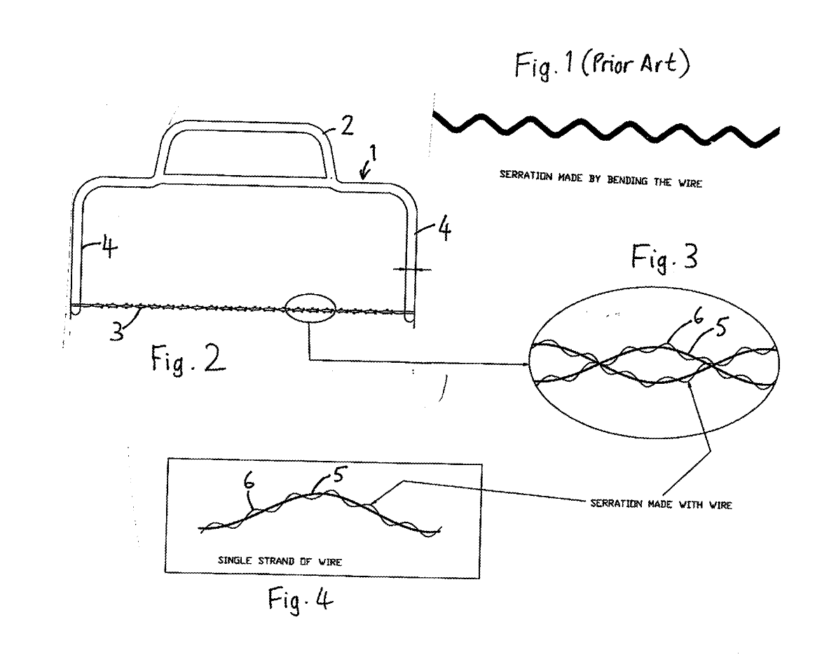

### DETAILED DESCRIPTION OF PARTICULAR EMBODIMENTS

FIG. 2 shows a cake leveller comprising a U-shaped frame 1 having a handle 2. A cable 3 is stretched horizontally between opposed arms 4 of the frame 1. The cable 3 will generally be higher than the position shown, the spacing between the cable and the ends of the arms 4 being adjustable depending on the required thickness of the cake to be cut.

As shown in FIGS. 3 and 4, the cable 3 comprises four wires intertwined in pairs. Each pair includes a thick wire 5 and a thin wire 6, giving a “serrated” effect. In this example, the thin wires 6 are wrapped around the respective thick wires 5 at a frequency six times that at which the pairs of wires 5, 6 are wrapped around each other.

The wires provide a blade that is particularly effective for cutting through cakes of all kinds and is more durable than the known wire.

1. A cake leveller comprising a rigid frame in the form of a bow with at least two taut intertwined wires extending horizontally between spaced parts of the frame.

2. A cake leveller according to claim 1, wherein exactly two intertwined wires are provided.

3. A cake leveller according to claim 2, wherein the wires are of unequal thicknesses.

4. A cake leveller according to claim 1, wherein an intertwined pair of wires is itself intertwined with at least one further intertwined pair of wires.

5. A cake leveller according to claim 4, wherein in each pair, the wires are of unequal thicknesses.

6. A cake leveller according to claim 5, wherein the spatial frequency at which the thin wires are wrapped around the thick wires is n times the spatial frequency at which the pairs of wires are wrapped around each other, n being an integer from 2 to 10 inclusive.

7. A cake leveller, substantially as described herewith with reference to the accompanying drawings.
